(19) United States
(12) Patent Application Publication
(10) Pub. No.: US 2001/0047560 A1
(43) Pub. Date: Dec. 6, 2001

(54) Dual-surface random pattern generating paint roller and method of producing a faux finish

(75) Inventor: David M. Tolchiner, Plymouth, MN (US)

Correspondence Address: Jeffery L. Cameron, NAWROCKI, ROONEY & SIVERTSON, P.A., Broadway Place East, Suite 401, 3433 Broadway Street Northeast, Minneapolis, MN, 55413, US

(73) Assignee: The Woolie, Inc.

(21) Appl. No.: 09/792,501

(22) Filed: Feb. 23, 2001

Related U.S. Application Data
(60) Provisional application No. 60/184,713, filed on Feb. 24, 2000.

(51) Int. Cl. B05C 17/02; B05D 1/28; B05D 5/00

(52) U.S. Cl. 15/230.11; 427/428; 427/260

(57) ABSTRACT

A faux finishing device including a paint roller having a core defined along a central axis. The core has an aperture therethrough that is aligned along the central axis. The device also has one or more roller bodies attached to the exterior surface of the core. Each body has an exterior surface that allows the device to create a random pattern when the body is coated with paint and placed in contact with a surface to be painted.

This application is a regular application filed under 35 U.S.C. Section 111(a) claiming priority, under 35 U.S.C. Section 119 (e)(1), of provisional application Ser. No. 60/184,713 previously filed Feb. 24, 2000 under 35 U.S.C. Section 111 (b).

### BACKGROUND OF THE INVENTION

The present invention relates generally to the field of the rolling of paint onto a surface. In particular, the present invention relates to an apparatus for faux finishing that creates a random painted pattern on a surface, presenting the appearance of a textured or marbled surface.

The use of paint rollers for applying paint to surfaces is generally known. Within this field of technology, there exist a variety of paint rollers having generally smooth surfaces and textured surfaces.

Smooth paint rollers are utilized to apply paint to a surface in a generally uniform manner, to provide a uniform surface color and texture. The concept of faux finishing was developed to provide a finish to a painted surface that gives the appearance of a textured or marbled surface. Some techniques of achieving this faux finish are utilized by applying paint to a surface in a random manner through use of: sponges, rags, feathers, or brushes.

Paint rollers are generally advantageous to painting because, in addition to applying paint in a uniform manner, they also apply paint to surfaces more quickly than other methods. Because of these advantages, attempts have been made provide a paint roller that can create a faux finish.

Traditionally, in order to form the appearance of a texture or marbled pattern by using a roller to apply paint on a surface, special rollers were developed that were formed with a fixed patterned roller surface, thereby laying the paint onto the surface to be painted in a non-uniform way. However, since the surface of the rollers contained a fixed pattern, as the roller rotated, the fixed pattern would be repeated on the wall as the roller moved along the surface. Several different methods of using these special rollers have been devised to try to hide the continuous pattern generation of these fixed pattern rollers.

In one method, a uniform base coat is applied to the surface. Then, a patterned roller is used to apply a number of patterned surface coats over each other. When applying the paint, the roller is angled at different directions for each respective coat. This method produces a multitude of uniform patterns over the surface, but since they are applied over one and other, they only to disguise the multitudes of defined patterns.

Another method, changes the direction of the roller as the paint is being applied. In this method, a uniform base coat is applied to the surface, then the user applies the faux finish with a patterned roller. The user turns the roller as it is moving along the surface. In this way the pattern snakes somewhat along the surface, and as further coats are applied over the pattern, the uniformity of the pattern is less noticeable.

Both of these methods, often times, do not hide the pattern and therefore the roller does not provide the appearance of a random surface that customers desire.

Therefore, there is a need in the field of faux finishing for an apparatus that provides a roller surface, that when it is rotated against a surface to be painted, its pattern changes to provide a random textured appearance to the surface to be painted. The apparatus should also provide a faux finish without requiring the user to put down a base coat before applying the faux finish. Further, the apparatus should also generally change its pattern when a new supply of paint is applied to the roller.

The present invention addresses these needs, as well as other problems associated with existing devices for faux finishing.

### SUMMARY OF THE INVENTION

The present invention relates to an apparatus for faux finishing that creates a random painted pattern on a painted surface. The apparatus includes a roller core and one or more roller bodies.

The roller core is typically a tube having an inner diameter and an elongated length. The core may have a shape, diameter, and length that are sized to fit any conventional paint rolling device.

The roller bodies are affixed to the exterior surface of the roller core and are comprised of a material, that is capable of providing a random pattern when it is pressed against a surface being painted.

The above mentioned benefits and other benefits of the invention will become clear from the following description by reference to the accompanying drawings.

### DESCRIPTION OF THE DRAWINGS

FIG. 1 is a top perspective view of the preferred embodiment of the invention, mounted to a traditional paint roller handle;

FIG. 2 is a side perspective view of the preferred embodiment of the present invention;

### DESCRIPTION OF THE PREFERRED EMBODIMENT

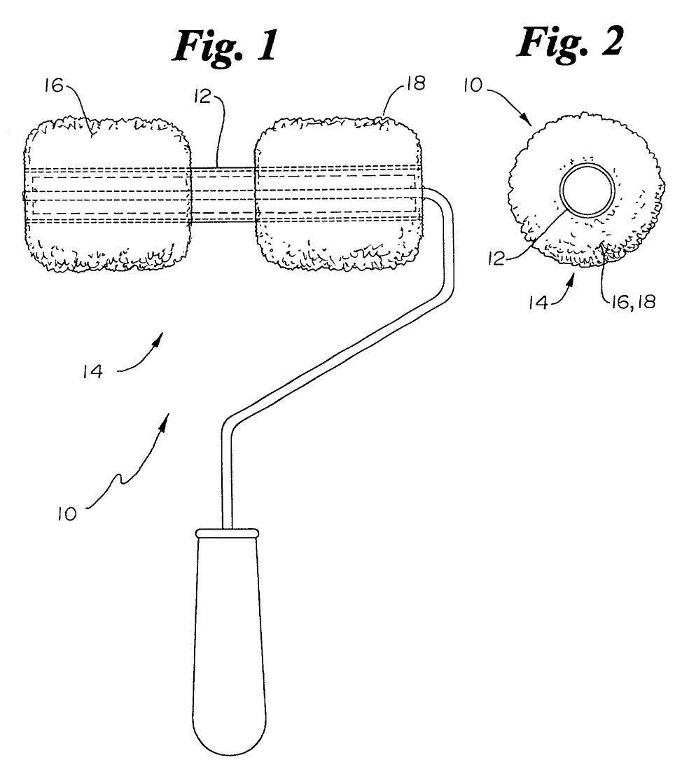

The present invention relates to an apparatus for faux finishing that creates a random painted pattern on a surface. The apparatus, as shown in FIGS. 1 and 2, is constructed in accordance with the present invention. As shown, the apparatus 10 includes a roller core 12 and at least one roller body 14.

The roller core 12 is generally an elongated tube having an interior diameter and an elongated length. The roller core may be constructed of any material known in the art. For example, cardboard, paperboard, or plastic have traditionally been used for the fabrication of roller cores and have been found to be suitable materials for the roller core of this apparatus. The overall length, the interior diameter, and general shape of the roller core may be sized and shaped to fit on any conventional paint rolling device.

Each roller body 14 is affixed to the exterior surface of the roller core 12. The bodies may be affixed by any means known in the art. Several roller bodies may be affixed to a single roller core. For example, as shown in FIG. 1, two bodies 16 and 18 are spaced from each other on a single core. The plurality of roller bodies are preferably spaced apart to provide a plurality of distinct roller surfaces. The roller bodies are preferably comprised of a thick nap, preferably between ¼ of an inch and 2 inches in thickness. The apparatus, as shown, has a nap of approximately 1 inch.

The material used for the nap should be a material having a fibrous construction such as natural or synthetic materials like sheepskin, cotton, polyester, flocked applicator surface materials and the like. By utilizing a material having a fibrous construction such as this, the fibers mat down upon each other, thereby varying the thickness of the nap and forming a random pattern. When the roller is rotated, the pattern is altered as the fiber structure is pressed between the roller core and the surface being painted, thereby creating a different pattern on the roller surface. Furthermore, when a fresh supply of paint is applied to the roller, the fibers are rearranged to form a different pattern configuration.

Through these changes in pattern, the roller has the ability to randomly change its surface pattern and thereby achieve a truly random surface pattern that more similarly mimics the appearance of a textured surface. By using a plurality of bodies, the roller produces a plurality of random patterns at one time.

The plurality of roller bodies can also be utilized to place several different colors or paints with different characteristics, for example, a different color on each body and each body having a random pattern, on a surface in a single application. This also enables the colors to be applied in different layers over each other.

For example, one roller is coated with a first color of paint and the second roller is coated with a second color. As the roller is rotated, two random patterns of paint, each in a different color, are applied to the surface in a single pass. When the roller is turned to a different angle, with respect to the first pass, and thereby rolled across the original layer of paint, the new layer provides two different colors over each first color, thereby creating a pattern in the paint that adds greater depth and dimension due to its intricate layering. This intricate layering allows the user to apply the pattern to a surface without a base coat because the surfaces of the roller bodies applies the paint to the entire surface in a uniformly random patterned layer.

Since many possible embodiments may be made of the present invention without departing from the scope thereof, it is to be understood that all matter herein set forth or shown in the accompanying drawings is to be interpreted in the illustrative and not a limiting sense.

What is claimed is:

1. A faux finishing device, comprising:
a paint roller having a core, defined along a central axis;
an aperture through said core aligned along said central axis; and
one or more roller bodies attached to the exterior surface of said core, each said body comprised of a means for creating a random pattern when said body is coated with paint and placed in contact with a surface to be painted.

2. The device according to claim 1, wherein said device has two roller bodies attached to said core, said bodies positioned on said core surface to define a space between said bodies.

3. The device according to claim 1, wherein said device has a plurality of roller bodies attached to said core, said bodies positioned on said core surface to define a space between each of said bodies.

4. The device according to claim 1, wherein said roller bodies are formed from a material comprising a multitude of fibers and said means for creating a random pattern is provided by the orientation of each of said fibers with respect to said other fibers.

5. The device according to claim 4, wherein said material is natural sheepskin.

6. The device according to claim 1, wherein said roller bodies are formed from a material that provides a thick nap surface.

7. The device according to claim 6, wherein said nap surface is at least one inch in thickness.

8. The device according to claim 1, wherein said roller bodies are formed from a material comprising a multitude of fibers, said fibers mat down upon each other to form a random patterned surface on each said body, thereby providing said means for creating a random pattern on said surface to be painted.

9. A faux finishing device for simultaneous use with two or more paint colors, comprising:
a paint roller having a core, defined along a central axis;
an aperture through said core aligned along said central axis; and
two or more roller bodies attached to the exterior surface of said core, each said body comprised of a means for creating a random pattern comprised of two or more simultaneously applied paint colors when said body is coated with paint and each said surfaces of said bodies are placed in contact with a surface to be painted.

10. A faux finishing device, comprising:
a paint roller having a core having a central axis and being adapted to be received on a paint roller handle having a portion constructed and arranged to rotate said paint roller about said central axis, said paint roller having two or more roller bodies attached to the exterior surface of said core, each said body comprised of a means for creating a random pattern when said surface is coated with paint and placed in contact with a surface to be painted.

11. A method of producing a faux finish on a surface to be painted, the step comprising;
providing a paint roller having a core, defined along a central axis, an aperture through said core aligned along said central axis, and one or more roller bodies attached to the exterior surface of said core, each said body comprised of a means for creating a random pattern when each said body is coated with paint and each said surfaces of said bodies are placed in contact with a surface to be painted;
applying paint to each said roller body;
contacting each said roller body with said surface to be painted.

12. The method according to claim 11, wherein the paint roller provided has two said roller bodies attached to said core, said bodies positioned on said core surface to define a space between said bodies.

13. The method according to claim 12, wherein a different color of paint is applied to each roller body.

14. The method according to claim 13, further comprising the step:
manipulating said paint roller such that paint applied by a second roller body is applied over paint applied by a first roller body.
